(19) United States
(12) Patent Application Publication
(10) Pub. No.: US 2005/0237422 A1
(43) Pub. Date: Oct. 27, 2005

(54) Image capturing sensor and image capturing apparatus

(75) Inventor: Toshihito Kido, Matsubara-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/042,923

(22) Filed: Jan. 25, 2005

(30) Foreign Application Priority Data
Apr. 21, 2004 (JP) JP2004-125318

(51) Int. Cl. H04N 5/335

(52) U.S. Cl. 348/362

(57) ABSTRACT

A plurality of pixels in a photoreception part of the image capturing sensor are divided into two groups: a first group for acquiring pixel signals for a motion picture, and a second group for acquiring the other pixel signals. A dedicated output system is disposed for each of the two groups, so that the pixel signals of the two groups can be outputted independently of each other. With the configuration, even when an instruction of acquiring a still picture is given during a period of capturing a motion picture, without being influenced by outputs of the second group, the pixel signals of the first group can be repeatedly outputted in predetermined time cycle.

This application is based on application No. 2004-125318 filed in Japan, the contents of which are hereby incorporated by reference.

### BACKGROUND OF THE INVENTION

1. Field of the Invention

The present invention relates to a technique of acquiring pictures and, more particularly, to a technique of acquiring both a moving picture and a still picture.

2. Description of the Background Art

Hitherto, there are known image capturing apparatuses such as a digital still camera and a digital video camera (hereinafter, generically referred to as “digital cameras”) capable of acquiring both a motion picture and a still picture. Generally, such an image capturing apparatus has an operation mode for acquiring a still picture and an operation mode for acquiring a motion picture. The operation modes are switched by an operation of the user.

In recent years, there has been proposed an image capturing apparatus capable of acquiring both of a motion picture and a still picture in the same period by giving a predetermined instruction within a period of capturing a motion picture.

The number of necessary pixels of a motion picture and that of a still picture are noticeably different from each other. For example, in recent years, as the number of pixels of a still picture, two to eight million pixels are required. On the other hand, a motion picture is generated on assumption that it is displayed on the screen of a television, so that relatively small number of pixels of about 150,000 to 300,000 pixels is sufficient for each frame. Consequently, in an image capturing sensor of the image capturing apparatus, to output pixel signals of one still picture, it takes much longer time than in the case of outputting pixel signals of one frame of a motion picture.

Therefore, at the time of acquiring a still picture within a period of capturing a motion picture in a conventional image capturing apparatus, the image capturing sensor cannot output pixel signals for a motion picture until outputting of the pixel signals of the still picture is completed. That is, due to an influence of output of the pixel signals of a still picture, the pixel signals (of a frame) of a motion picture cannot be outputted for a predetermined time period. Consequently, a motion picture captured in the image capturing period in which also a still picture is acquired is very unnatural due to a dropout of a frame in the period of a still picture outputting process and the like.

In order to grasp the state of a subject in the period a frame of such a motion picture is not acquired (that is, the period of the still picture process), it is necessary to recognize the still picture captured in the period of capturing the motion picture. It is, however, not easy to specify the still picture.

### SUMMARY OF THE INVENTION

The present invention is directed to an image capturing sensor.

According to the present invention, the image capturing sensor comprises: a plurality of pixels divided into two or more groups and acquiring pixel signals by exposure to light; and an output part having two or more output systems corresponding to the two or more groups in a one-to-one corresponding manner. Each of the two or more output systems outputs pixel signals acquired by the pixels of the corresponding group.

Since each of the two or more output systems outputs pixel signals acquired by the pixels of the corresponding group, the pixel signals of the two or more groups can be outputted in parallel. The pixel signals of a desired group can be outputted without being influenced by the output state of the pixel signals of the other group.

According to an aspect of the present invention, the image capturing sensor comprises: a plurality of pixels divided into two or more groups and acquiring pixel signals by exposure to light; an output part for outputting pixel signals acquired by the plurality of pixels; and a drive part for repeatedly driving the output part in predetermined process cycles. Each of the process cycles is divided into two or more output periods for outputting the pixel signals acquired by the two or more groups from the output part.

By assigning a relatively long period as a period for outputting the pixel signals of a desired group, the pixel signals of the group can be outputted preferentially without being influenced by the output state of the pixel signals of the other group. The pixel signals of the other group can be also output in parallel with outputting of the pixel signals of the desired group.

The present invention is also directed to an image capturing apparatus.

According to the present invention, the image capturing apparatus comprises: a plurality of pixels divided into two or more groups for acquiring pictures of different properties, and acquiring pixel signals by exposure to light; and an output part capable of outputting the pixel signals acquired by the two or more groups in parallel.

Since the pixel signals acquired by the two or more groups can be outputted in parallel, the pixel signals of a group related to a picture of a desired property can be outputted without being influenced by the output state of the pixel signals of the other group.

According to another aspect of the present invention, the image capturing apparatus comprises: an image capturing part capable of acquiring a still picture within a period of capturing a motion picture; and a recording controller for recording a motion picture and a still picture which is acquired within the period of capturing the motion picture so as to be associated with each other.

Since a motion picture and a still picture captured in the period of capturing the motion picture are recorded so as to be associated with each other, the still picture captured within the period of capturing the motion picture can be easily specified at a later time.

Therefore, an object of the present invention is to provide a technique capable of outputting pixel signals of desired pixels without being influenced by the output state of pixel signals of other pixels.

Another object of the present invention is to provide a technique capable of easily specifying a still picture captured within the period of capturing a motion picture at a later time.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a digital camera;

FIG. 2 is a rear view of the digital camera;

FIG. 3 is a block diagram showing an example of main internal components of the digital camera;

FIG. 4 is a diagram showing an example of layout of pixels of an image capturing sensor;

FIG. 5 is a diagram schematically showing an example of the configuration of the image capturing sensor;

FIG. 6 is a schematic view of a picture file of a still picture;

FIG. 7 is a schematic view of a picture file of a motion picture;

FIG. 8 is a diagram showing the flow of operations in a motion picture mode;

FIG. 9 is a time chart showing operations in a period of capturing motion pictures;

FIG. 10 is a diagram schematically showing processes until a still picture is generated;

FIG. 11 is a diagram showing the flow of operations in a display mode;

FIG. 12 is a diagram showing a display example of a liquid crystal monitor;

FIG. 13 is a diagram showing a display example of the liquid crystal monitor;

FIG. 14 is a block diagram showing an example of main internal components of the digital camera;

FIG. 15 is a diagram schematically showing an example of the configuration of the image capturing sensor;

FIG. 16 is a time chart showing operations in the period of capturing a motion picture;

FIG. 17 is a diagram showing an example of layout of pixels of the image capturing sensor;

FIG. 18 is a diagram schematically showing an example of the configuration of the image capturing sensor; and

FIG. 19 is a diagram showing a display example of the liquid crystal monitor.

### DESCRIPTION OF THE PREFERRED EMBODIMENTS

Hereinafter, preferred embodiments of the present invention will be described in detail with reference to the drawings. In the following description, a digital camera as an example of an image capturing apparatus will be described.

1. First Preferred Embodiment

1-1. Outside Configuration

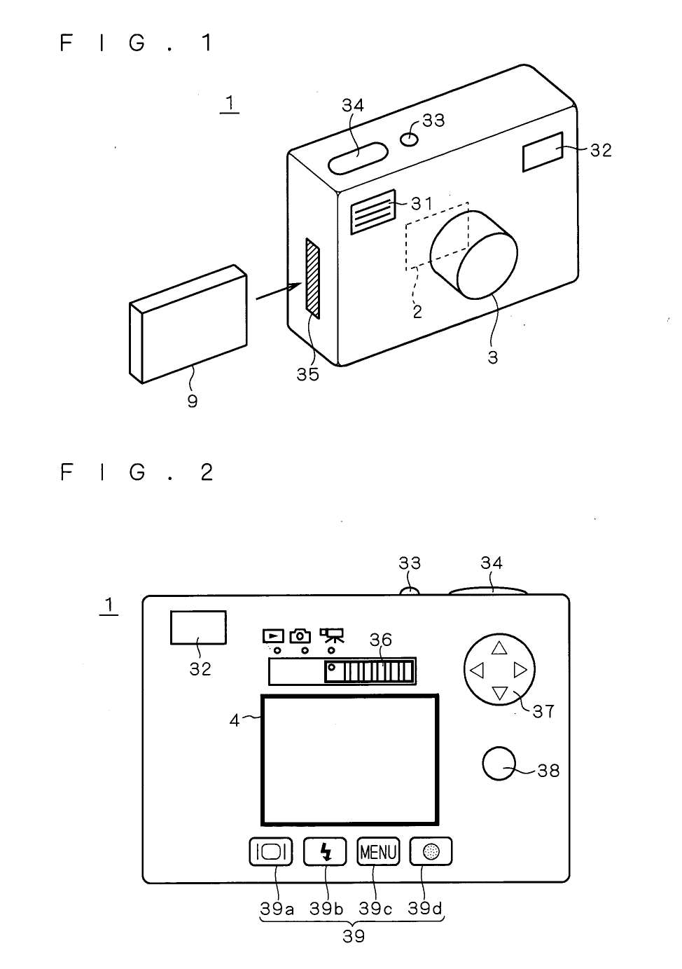

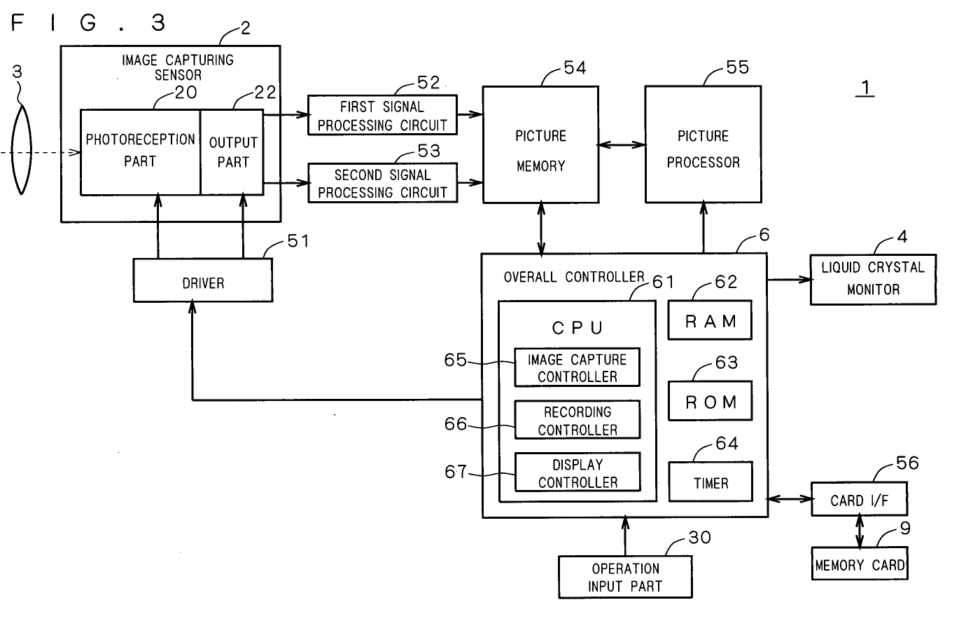

FIG. 1 is a perspective view of a digital camera 1. FIG. 2 is a diagram showing a configuration on the rear face side of the digital camera 1. The digital camera 1 is constructed so that both of a still picture and a motion picture can be acquired.

As shown in FIG. 1, on the front face side of the digital camera 1, an electronic flash 31, an objective window of an optical viewfinder 32, and a taking lens 3 having plural lens units are provided. In a proper place in the digital camera 1 as a position rearward of the taking lens 3, an image capturing sensor 2 for capturing a picture of a subject via the taking lens 3 is provided.

On the top face side of the digital camera 1, a shutter start button 34 for accepting an image capture instruction from the user and a main switch 33 for switching the on/off state of the power source are disposed.

In a side face of the digital camera 1, a card slot 35 to which a memory card 9 as a recording medium can be inserted is formed. A still picture and a motion picture acquired by the digital camera 1 are recorded on the memory card 9.

As shown in FIG. 2, on the rear face side of the digital camera 1, an eyepiece window of the optical viewfinder 32, a mode switching lever 36 for switching the operation mode, a liquid crystal monitor 4 for performing various displays, a cross key 37 for accepting a user operation, an execution button 38, a function button group 39 (39a to 39d) are provided.

The liquid crystal monitor 4 performs various displays such as a display of a still picture recorded on the memory card 9, a playback display of a motion picture, and a display of a setting menu for settings. In an image capturing standby state, a motion picture capturing period and the like, the liquid crystal monitor 4 displays a live view an almost real-time state of a subject. The liquid crystal monitor 4 is also used in place of a viewfinder for framing.

To the cross key 37, execution button 38 and function button group 39, functions are dynamically assigned in accordance with an operation mode and an operation state of the digital camera 1. The cross key 37 consists of four buttons showing up, down, right and left ways and is used mainly for moving an item and selecting a picture to be displayed. The execution button 38 is used for various determinations.

The digital camera 1 has three operation modes of “still picture mode”, “motion picture mode” and “display mode”. The operation modes can be switched by sliding the mode switching lever 36. The “still picture mode” is an operation mode for obtaining a still picture, and the “motion picture mode” is an operation mode for acquiring a motion picture.

In the “still picture mode”, a signal for instructing acquisition of a still picture (hereinafter, referred to as “still picture acquisition signal”) is generated by depression of the shutter start button 34. In response to the signal, a still picture is acquired.

In the “motion picture mode”, a signal instructing start of capture of a motion picture (hereinafter, referred to as “motion picture capture start signal”) is generated by depression of the execution button 38. In response to the signal, capture of a motion picture starts. When the execution button 38 is depressed again during the capture of the motion picture, a signal instructing end of the capture of the motion picture (hereinafter, referred to as “motion picture capture end signal”) is generated, and the capture of the motion picture is finished. That is, the period from generation of the “motion picture capture start signal” until generation of the “motion picture capture end signal” (between the depressions of the execution button 38) is a motion picture capturing period.

Also when the shutter start button 34 is depressed in the motion picture capturing period, the “still picture acquisition signal” is generated. In response to the signal, a still picture is acquired in addition to a motion picture. That is, in the “motion picture mode”, both of the motion and still pictures can be acquired in the same period.

The “display mode” is an operation mode for displaying a still picture and a motion picture acquired in the “still picture mode” and the “motion picture mode”, respectively, onto the liquid crystal monitor 4. In the specification, the terms “playback display of a motion picture” are used as the meaning of “display of a dynamic motion picture accompanying sequential switching of frames”, that is, “display of a dynamic motion picture which is not in a still state”. The “display of a motion picture” includes here “display of a motion picture in a still state” and the “playback display of a motion picture”.

1-2. Inside Configuration

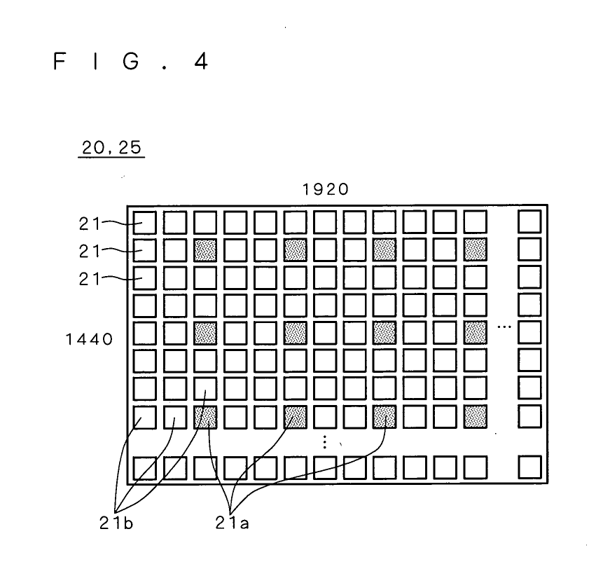

FIG. 3 is a block diagram showing main internal components of the digital camera 1. As shown in the diagram, the digital camera 1 has therein an overall controller 6 for controlling the whole apparatus in a centralized manner. The overall controller 6 is constructed by including a microcomputer and has a CPU 61 for performing various computing processes, a RAM 62 used as a work area of computation or the like, a ROM 63 for storing a control program, data and the like, and a timer 64 as a timer circuit. The processors of the digital camera 1 are electrically connected to the overall controller 6 and operate under control of the overall controller 6.

The image capturing sensor 2 of the preferred embodiment takes the form of a CCD sensor. The image capturing sensor 2 has a photoreception part 20 for photoelectrically converting a light image of a subject formed by the taking lens 3 to a pixel signal (charge signal), and an output part 22 for outputting the pixel signal obtained by the photoreception part 20.

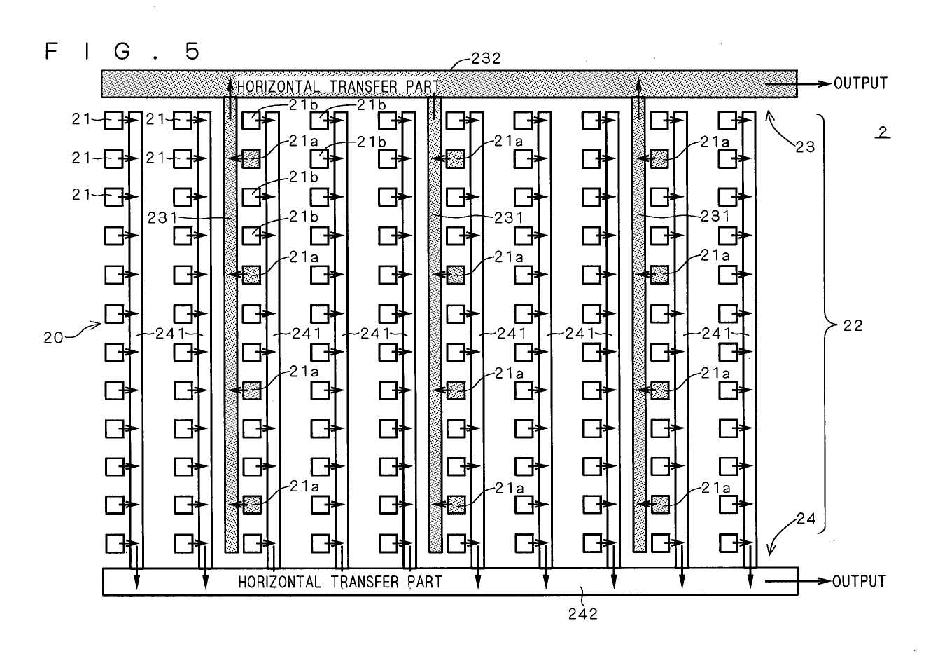

The photoreception part 20 of the image capturing sensor 2 is constructed by a plurality of pixels 21 which are two-dimensionally arranged in, for example, 1920 pixels in the horizontal direction×1440 pixels in the vertical direction as shown in FIG. 4. Each pixel 21 is constructed by a photodiode and, by exposure, generates a pixel signal according to an exposure amount.

For generation of a still picture, pixel signals of all of the pixels 21 are used. In the digital camera 1 of the preferred embodiment, a still picture made of 1920 pixels in the horizontal direction×1440 pixels in the vertical direction is generated. On the other hand, at the time of generating a motion picture, the pixel signals of all of the pixels 21 are not always used but pixel signals of only a part of the pixels 21a (hatched pixels in FIG. 4) are used.

Specifically, the plurality of pixels 21 included in the photoreception part 20 is divided into two groups: a group of pixels 21a for acquiring pixel signals used for generating a motion picture, and a group of other pixels 21b used for mainly generating a still picture. Hereinafter, the group to which the pixels 21a for obtaining the pixel signals used for generating a motion picture belong will be referred to as a “first group” and the group to which the other pixels 21b belong will be referred to as a “second group”.

As shown in FIG. 4, the pixels 21a of the first group exist at the ratio of one pixel in three pixels in each of the vertical and horizontal directions, and the pixels 21a of 640 pixels in the horizontal direction×480 pixels in the vertical direction exist in the whole photoreception part 20. That is, the pixel signals of the pixels 21a of 640 pixels in the horizontal direction×480 pixels in the vertical direction are used as one frame of a motion picture. By connecting a plurality of frames, a motion picture is generated.

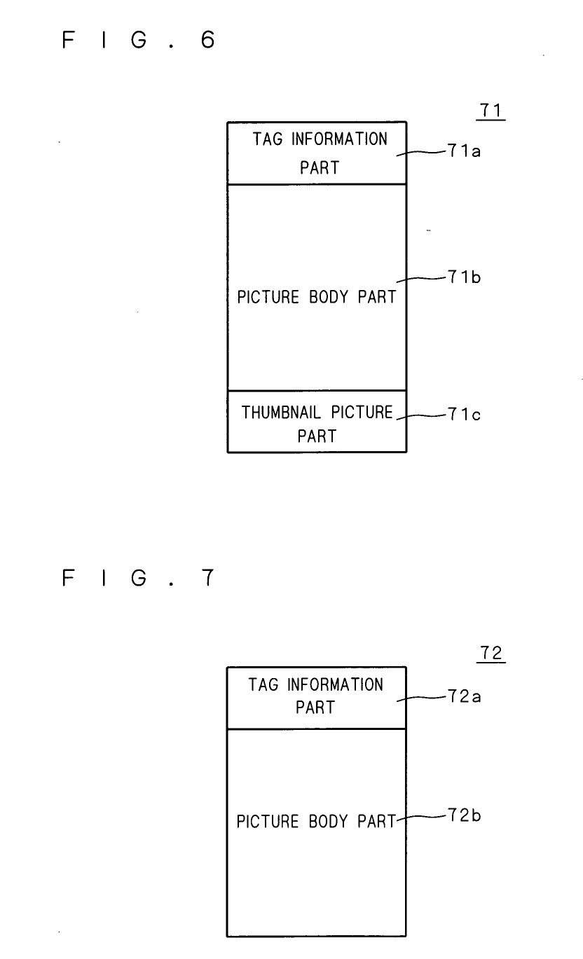

The pixel signals obtained in the pixels 21 of the photoreception part 20 of the image capturing sensor 2 are read and outputted from the output part 22 while being transferred. FIG. 5 is a diagram schematically showing the configuration of the image capturing sensor 2 including the output part 22.

As shown in FIG. 5, the output part 22 of the image capturing sensor 2 of the preferred embodiment has two output systems 23 and 24 (first output system 23 and second output system 24). The first output system 23 includes a vertical transfer part 231 and a horizontal transfer part 232. The second output system 24 includes a vertical transfer part 241 and a horizontal transfer part 242. The vertical transfer parts 231 and 241 are disposed in correspondence with vertical pixel columns (columns of the pixels 21 arranged in the vertical direction) of the photoreception part 20 and read and transfer the pixel signals from the pixels 21. On the other hand, the horizontal transfer parts 232 and 242 are connected to the vertical transfer parts 231 and 241, respectively, and transfer and output the pixel signals from the vertical transfer parts 231 and 241.

The two output systems 23 and 24 correspond to two groups in the photoreception part 20. Each of the two output systems 23 and 24 outputs only the pixel signals of the corresponding group. More concretely, the first output system 23 outputs only the pixel signals of the pixels 21a belonging to the first group, and the second output system 24 outputs only the pixel signals of the pixels 21b belonging to the second group. Consequently, for a vertical pixel column including the pixels 21a belonging to the first group, both of the vertical transfer parts 231 and 241 of the two output systems 23 and 24 are disposed. For the other vertical pixel columns, only the vertical transfer part 241 of the second output system 24 is disposed.

As described above, in the image capturing sensor 2 of the preferred embodiment, the dedicated output systems 23 and 24 are provided for the two groups into which the pixels 21 are divided. Therefore, the pixel signals in the two groups can be outputted independently of each other. The pixel signal in one of the groups can be outputted without being influenced by an output state of the other group. Therefore, the pixel signals of the two groups can be outputted simultaneously and concurrently. Hereinafter, the function capable of independently outputting pixel signals for each of the groups of the image capturing sensor 2 will be referred to as an “independent output function”.

The image capturing sensor 2 is driven on the basis of a drive signal transmitted from a driver 51 shown in FIG. 3. The driver 51 transmits a drive signal instructing start of exposure and end of exposure to the photoreception part 20 on the basis of the signal from the overall controller 6, and transmits a drive signal instructing output of the pixel signal to the output part 22. Such a drive signal from the driver 51 is transmitted for each of the groups in the photoreception part 20 and for each output system of the output part 22. With the configuration, the photoreception part 20 is driven on the basis of the group and the output part 22 is driven on the basis of the output system.

As shown in FIG. 3, the digital camera 1 has two signal processing circuits (a first signal processing circuit 52 and a second signal processing circuit 53). Since the image capturing sensor 2 has the two output systems 23 and 24, an analog image signal (a signal constructed by a signal train of pixel signals) is outputted from each of the two output systems 23 and 24. Specifically, image signals of the first group are outputted from the first output system 23, and image signals of the second group are outputted from the second output system 24. The two signal processing circuits 52 and 53 are provided to perform predetermined analog signal processes on the two image signals.

The first and second signal processing circuits 52 and 53 have the same configuration including a CDS (Correlated Double Sampling) circuit, an AGC (auto gain control) circuit, and an A/D converter. The two image signals outputted from the image capturing sensor 2 are subjected to noise reduction, level adjustment, and conversion to digital signals by the signal processing circuits 52 and 53. The digital image signals (hereinafter, simply referred to as “pictures”) processed and outputted from the signal processing circuits 52 and 53 are stored into a picture memory 54 capable of storing various pictures.

A picture processor 55 performs various picture processes on the pictures stored in the picture memory 54. Concretely, the picture processor 55 performs various picture processes such as a color adjusting process, a γ correcting process, and a picture compressing/decompressing process. By the processes of the picture processor 55, a display picture adapted to be displayed on the liquid crystal monitor 4, a compressed picture adapted to be recorded on the memory card 9, and the like are generated. Further, in the motion picture mode, a motion picture and a still picture are generated by the picture processor 55 (the details will be described later).

A card I/F 56 performs recording of a picture to the memory card 9 to be inserted into the card slot 35, reading of a picture from the memory card 9, and the like. The card I/F 56 is electrically connected to the overall controller 6 and performs recording and reading of a picture on the basis of a signal from the overall controller 6. The liquid crystal monitor 4 is also electrically connected to the overall controller 6 and performs various displays such as a display of a still picture and a playback display of a motion picture under control of the overall controller 6.

An operation input part 30 is expressed as a function block of operation members including the shutter start button 34, mode switching lever 36, cross key 37, execution button 38, and function button group 39. When the operation part 30 is operated, a signal instructing a process or control according to the operation is generated and inputted to the overall controller 6. Such a signal is recognized as, for example, the “still picture acquisition signal”, “motion picture capture start signal”, “motion picture capture end signal” or the like and the process or control according to the signal is performed by the overall controller 6.

The overall controller 6 has various functions related to the control of the digital camera 1. Such functions are realized when the CPU 61 performs a computing process in accordance with a control program stored in the ROM 63 (that is, in a software manner). The control program is pre-stored in the ROM 63. It is also possible to store a new control program which is, for example, read from the memory card 9, into the ROM 63. In FIG. 3, an image capture controller 65, a recording controller 66, and a display controller 67 schematically show a part of the functions of the overall controller 6 realized in a software manner.

The image capture controller 65 performs a control of acquiring a still picture and a motion picture in the “still picture mode” and the “motion picture mode”. For example, when the “still picture acquisition signal” is generated by depression of the shutter start button 34, the image capture controller 65 generates an instruction signal for making the image capturing sensor 2 perform exposure to acquire a still picture and transmits the instruction signal to a driver 51.

The recording controller 66 performs a control on recording of a still picture and a motion picture acquired under control of the image capture controller 65 into the memory card 9. By the control of the recording controller 66, both of the still picture and motion picture of the preferred embodiment are formed as picture files to which various attribute information is added. After that, peculiar file names are added to the picture files, and the resultant picture files are recorded in the memory card 9.

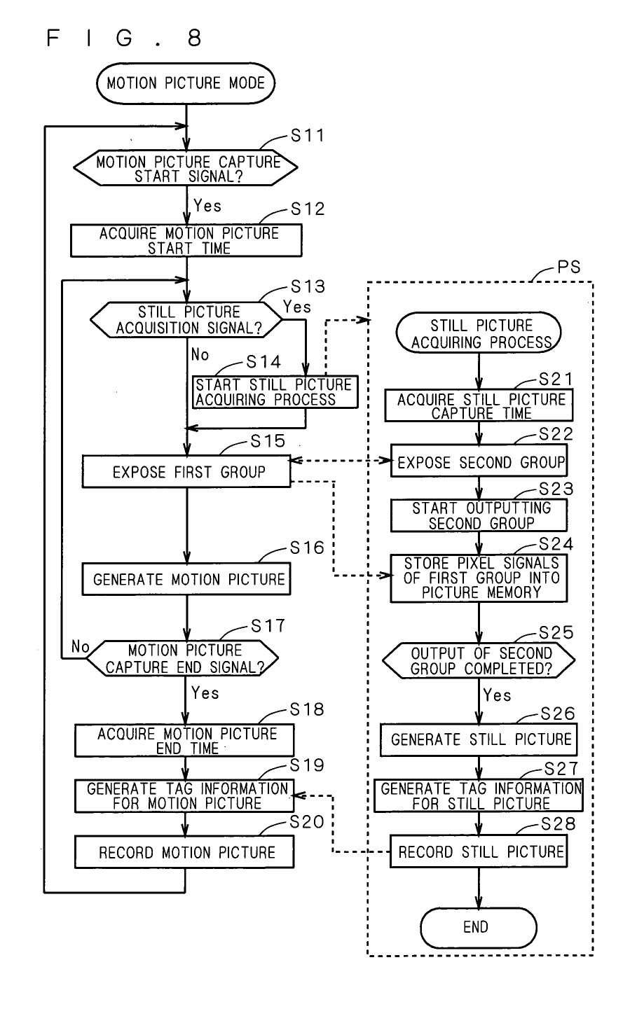

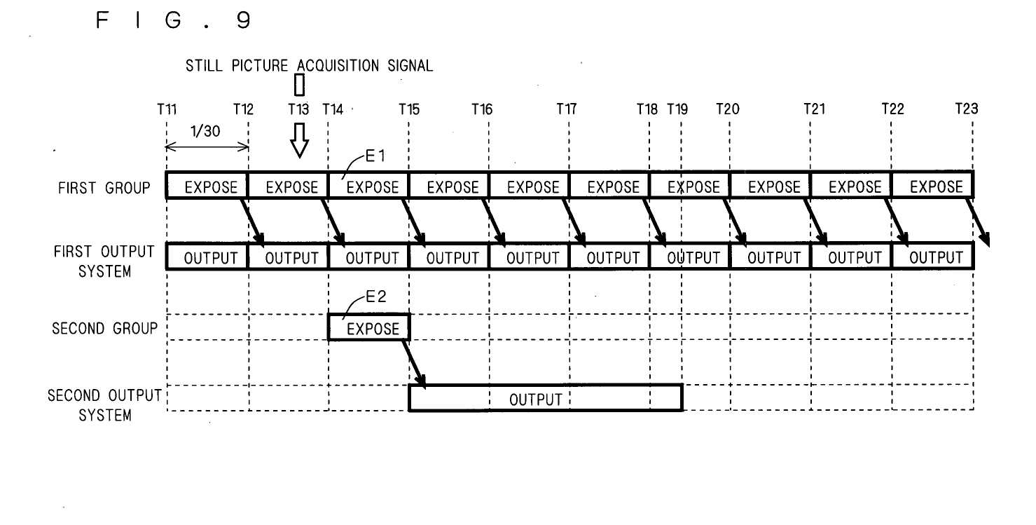

FIG. 6 is a schematic view of a picture file 71 of a still picture, and FIG. 7 is a schematic view of a picture file 72 of a motion picture. As shown in FIG. 6, the picture file 71 of a still picture is of the Exif (Exchangeable Image File Format) and is constructed by a tag information part 71a, a picture body part 71b and a thumbnail picture part 71c. A still picture itself is stored in the picture body part 71b, and a thumbnail picture of relatively low resolution is stored in the thumbnail picture part 71c. In the tag information part 71a, tag information (various information indicative of image capture parameters and the like) for explaining the still picture stored in the picture body part 71b is written by control of the recording controller 66.

On the other hand, as shown in FIG. 7, the picture file 72 of a motion picture is constructed by a tag information part 72a and a picture body part 72b. Also in the picture file 72, a motion picture itself is stored in the picture body part 72b, and tag information for explaining the motion picture is written in the tag information part 72a by the control of the recording controller 66.

Referring again to FIG. 3, the display controller 67 executes a control regarding display of the liquid crystal monitor 4 and performs, for example, a control for displaying a still picture and a motion picture onto the liquid crystal monitor 4 in the “display mode”. In the “display mode”, an arbitrary picture in the memory card 9 is selected by the user. If the selected picture is a still picture, the still picture is displayed on the liquid crystal monitor 4. On the other hand, if the selected picture is a motion picture, first, the motion picture is displayed in a still state on the liquid crystal monitor 4. When the execution button 38 is depressed, the motion picture is playback displayed.

1-3. Operation in Motion Picture Mode

The operation of the digital camera 1 will now be described. First, the operation in the motion picture mode will be described.

1-3-1. Basic Operation

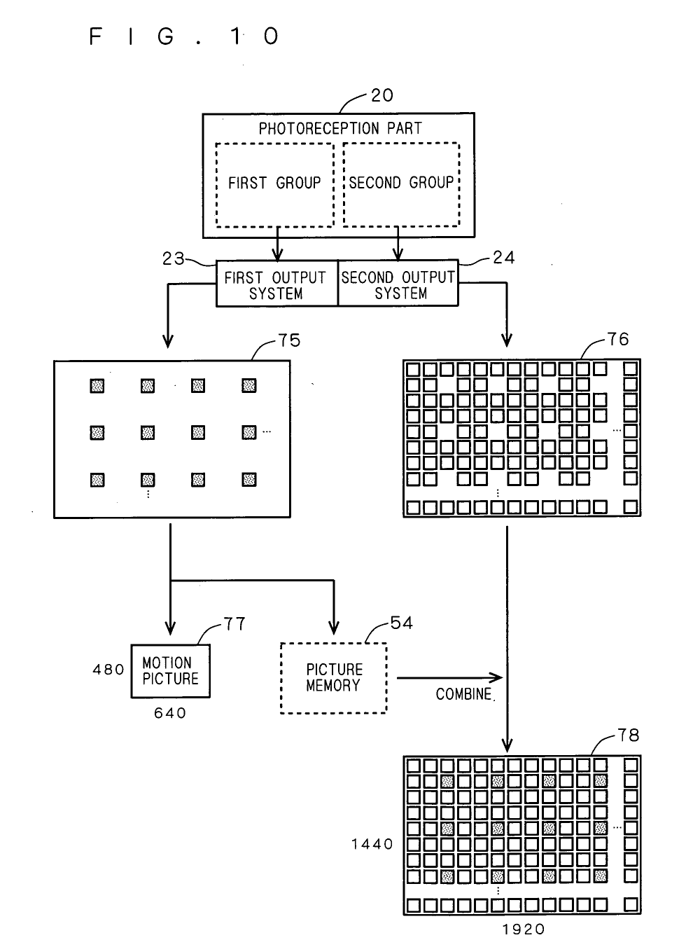

FIG. 8 is a diagram showing the flow of operations in the motion picture mode of the digital camera 1. When the digital camera 1 is set in the motion picture mode, first, the digital camera 1 enters a standby state of generating the “motion picture capture start signal” (depression of the execution button 38). At this time, a live view is displayed on the liquid crystal monitor 4 (step S11).

When the “motion picture capture start signal” is generated by depression of the execution button 38 in the standby state, in response to the signal, the absolute time at that time point is obtained as “motion picture start time” by the timer 64. The obtained “motion picture start time” is stored in the RAM 62 (step S12).

The period until the “motion picture capture end signal” is generated by re-depression of the execution button 38 (during “No” in step S17) is the period of capturing a motion picture. In the motion picture capture period, exposure (step S15) and motion picture generating process (step S16) are repeated in predetermined time intervals.

Specifically, since frames for a motion picture are obtained in predetermined time intervals, exposure (step S15) of the pixels 21a in the first group of the image capturing sensor 2 is repeated in the predetermined time intervals by control of the overall controller 6. In the preferred embodiment, the time interval for repeating the exposure is 1/30 second.

On the other hand, on the basis of pixel signals obtained by exposure of the first group, a motion picture is generated (step S16). Specifically, the pixel signals of the first group are outputted from the first output system 23 of the image capturing sensor 2, predetermined processes are performed on the pixel signals by the first signal processing circuit 52, and a picture of 640 pixels in the horizontal direction×480 pixels in the vertical direction (hereinafter, referred to as “first picture”) is generated. The first picture is stored in the picture memory 54 and connected to a motion picture being generated as a frame of a motion picture by the picture processor 55. By repeating such a process in 1/30 second cycles, motion pictures are sequentially generated. The first picture is also displayed on the liquid crystal monitor 4, thereby displaying a live view also in the period of capturing a motion picture.

FIG. 8 illustrates that, for convenience of the drawing, after the exposure (step S15), the motion picture generating process (step S16) is performed and, then, the next exposure (step S15) is performed. In practice, however, steps S15 and S16 are performed in parallel. That is, when attention is paid to each of the processes, the process is repeated in the cycles of 1/30 second almost without any time interval.

When the “motion picture capture end signal” is generated by re-depression of the execution button 38 in the motion picture capturing period (“Yes” in step S17), in response to the signal, repetition of the exposure (step S15) and the motion picture generating process (step S16) is finished, and a final motion picture is obtained. In addition, the absolute time of the time point is acquired as “motion picture end time” by the timer 64 (step S18).

Next, by the control of the recording controller 66, tag information including the “motion picture start time” and “motion picture end time” is generated (step S19). The tag information is added to the acquired motion picture, and a picture file is generated. To the picture file, peculiar file name is also added. The resultant file is recorded in the memory card 9 (step S20).

1-3-2. Acquisition of Still Picture

The basic operation of the motion picture mode has been described above. In the motion picture mode, when the shutter start button 34 is depressed in the motion picture capturing period, the “still picture acquisition signal” is generated. In response to the signal, a still picture is acquired. Hereinafter, the operation of the digital camera 1 performed when the “still picture acquisition signal” is generated in the motion picture capturing period will be described.

As described above, in the motion picture capturing period, the exposure (step S15) and the motion picture generating process (step S16) are repeated in the predetermined time cycle. When the “still picture acquisition signal” is generated by depression of the shutter start button 34 (“Yes” in step S13), in response to the signal, a still picture acquiring process PS shown in a right lower part in FIG. 8 is called and started (step S14).

The still picture acquiring process PS is a process which can be executed in parallel with the basic operation of the motion picture mode. Therefore, also after the still picture acquiring process PS is started, repetition of the exposure (step S15) and the motion picture generating process (step S16) is continued.

In the still picture acquiring process PS, first, the absolute time at that time is acquired as “still picture capture time” by the timer 64. The acquired capture time is stored in the RAM 62 (step S21).

Next, by the drive signal from the driver 51, exposure of the pixels 21b in the second group of the image capturing sensor 2 is performed. The start time point and the end time point of the exposure of the pixels 21b in the second group and those of exposure of the pixels 21a in the first group immediately after generation of the “still picture capturing signal” match each other. That is, the exposure timings (exposure start time point and the exposure time) in the first group and those in the second group coincide with each other (step S22).

Next, outputting of the pixel signals in the second group starts from the second output system 24 of the image capturing sensor 2 (step S23). The output pixel signals are sequentially processed by the second signal processing circuit 53 and converted to digital signals and, after that, stored into the picture memory 54.

Since the number of pixels in the second group is larger than that in the first group, it takes longer time to output the pixel signals in the second group as compared with the first group. However, since the image capturing sensor 2 of the preferred embodiment has the independent output function, also at the time of outputting the pixel signals in the second group, the pixel signals in the first group are outputted without being influenced by the output of the pixel signals in the second group.

With respect to the pixel signals of both of the groups obtained by exposure at the same timing, outputting of the first group is completed before the second group. The pixel signals of the groups are combined by a following process, thereby obtaining one still picture (the details will be described later). Consequently, the pixel signals in the first group of which exposure timing coincides with that of the second group are stored as a first picture in the picture memory 54 until outputting of the pixel signals in the second group is completed (step S24).

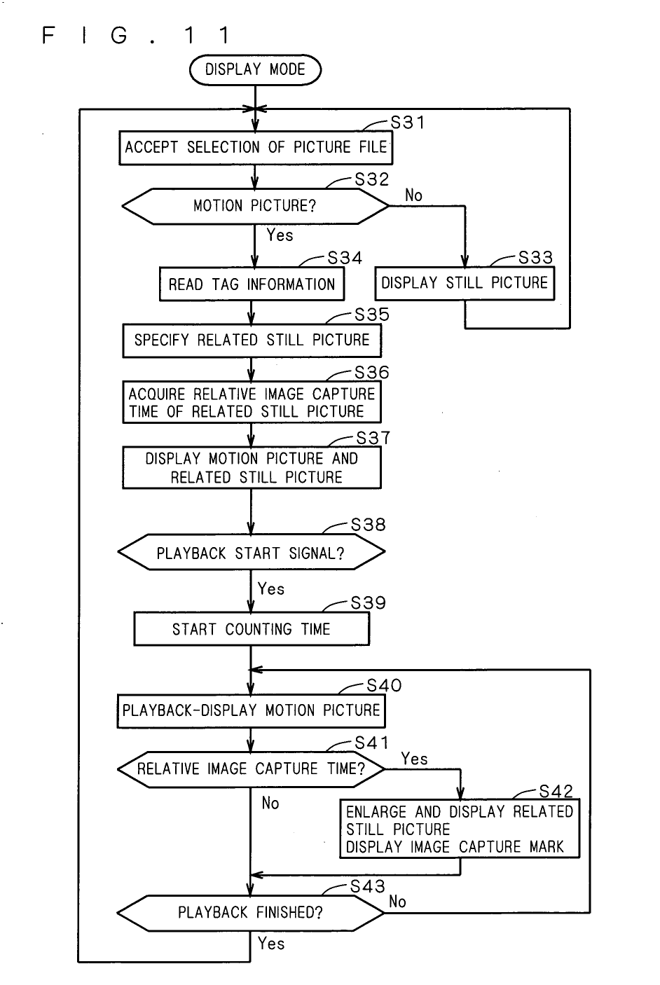

FIG. 9 is a time chart showing operations of the digital camera 1 performed when the “still picture capture signal” is generated during the motion picture capturing period.

In the motion picture capturing period, as shown in the diagram, exposure of the first group is repeated in the cycles of 1/30 second. The exposure of once corresponds to acquisition of the pixel signals of one frame in a motion picture. In addition, outputting from the first output system 23 of the pixel signals related to the latest exposure is repeated in the cycles of 1/30 second.

In such a state, for example, when the “still picture capture signal” is generated at the time point T13, exposure E2 of the second group starts on start of exposure E1 by the first group immediately after generation of the “still picture capture signal” (time point T14). On completion of the exposure E1 of the first group, the exposure E2 of the second group is also finished (time point T15). That is, the timings of the exposures E1 and E2 coincide with each other.

After the exposures E1 and E2 are finished, by using the independent output function of the image capturing sensor 2, the pixel signals related to the exposure E1 of the first group are outputted from the first output system 23. Concurrently, the pixel signals related to the exposure E2 of the second group are outputted from the second output system 24 (from time point T15).

The outputting of the pixel signal related to the exposure E1 is completed at time point T16. On the other hand, outputting of the pixel signal related to the exposure E2 is completed at time point T19 later than the time point T16. The pixel signals related to the exposure E1 completed to be outputted at time T16 are stored as a first picture at the time point T16 into the picture memory 54 so as to be provided for generation of a still picture performed later.

In the first output system 23, after outputting of the pixel signals related to the exposure E1 is completed (time point T16), the pixel signals related to the next exposure (that is, related to the next frame) of the exposure E1 are outputted. After that, in the first output system 23, the pixel signals of the first group as a frame in a motion picture are outputted in the cycles of 1/30 second. That is, irrespective of the output period of the pixel signals of the second group (from time point T15 to time point T19), by using the independent output function of the image capturing sensor 2, the pixel signals of the first group are repeatedly outputted in the cycles of 1/30 second.

Referring again to FIG. 8, after completion of outputting of the pixel signals in the second group from the second output system 24 (“Yes” in step S25), a picture made of pixel signals in the second group (hereinafter, referred to as “second picture”) and a first picture of pixel signals in the first group of which exposure timing coincides with that of the second group are stored in the picture memory 54. In response to completion of outputting of the pixel signals in the second group, the second and first pictures are combined by the process of the picture processor 55, thereby generating one still picture (step S26).

FIG. 10 is a diagram schematically showing processes of the digital camera 1 to generate the still picture. As shown in the diagram, out of the pixel signals obtained by the exposures whose timings coincide with each other, pixel signals related to the first group of the photoreception part 20 are outputted from the first output system 23 and are formed as a first picture 75. The pixel signals related to the second group are outputted from the second output system 24 and are formed as a second picture 76. The first picture 75 generated before the second picture 76 is used as a frame in a motion picture 77 and is also stored in the picture memory 54.

On the other hand, when outputting of the second group is completed and the second picture 76 is generated, the second picture 76 and the first picture 75 in the picture memory 54 are combined to each other, thereby generating a still picture 78. More concretely, the pixel signals of the second picture 76 and the pixel signals of the first picture 75 are re-arranged in accordance with arrangement of the pixels 21 in the photoreception part 20, thereby generating one still picture 78.

Referring again to FIG. 8, after the still picture is generated in such a manner, tag information for the still picture including the “still picture capturing time” is generated (step S27). The tag information and a thumbnail picture are added to the generated still picture, thereby generating a picture file. To the picture file, peculiar file name is added. The resultant is recorded in the memory card 9 (step S28).

The still picture acquiring process PS described above is performed each time the “still picture acquisition signal” is generated (each time the shutter button 34 is depressed) in the motion picture capturing period. Therefore, the digital camera 1 can acquire a plurality of still pictures in the period of capturing one motion picture.

When the still picture is obtained as described above in the period of capturing a certain motion picture, by the control of the recording controller 66, the file name of a picture file of the obtained still picture is written as a part of the tag information at the time of generation of the tag information of the motion picture (step S19). In such a manner, a motion picture and a still picture captured in the period of capturing the motion picture are associated with each other and recorded in the memory card 9. In other words, a still picture and a motion picture including pixel signals of the first group as a part of the still picture are associated with each other and recorded (step S20).

As described above, in the digital camera 1, the image capturing sensor 2 has the two output systems 23 and 24, and each of the two output systems 23 and 24 outputs pixel signals of only a corresponding group independently of each other. Consequently, the pixel signals of two groups can be outputted in parallel with each other, and the pixel signals of the first group related to a motion picture can be outputted without being influenced by the output state of the pixel signals of the second group. As a result, a frame for a motion picture can be acquired in predetermined time cycles even in the period of the still picture process, and a motion picture without a frame dropout can be obtained. Similarly, a frame dropout due to acquisition of a still picture during live view display in the motion picture capturing period can be also prevented. Therefore, smooth framing can be realized in the motion picture capturing period.

When the “still picture acquisition signal” is generated in the period of capturing a motion picture, the pixels 21a in the first group and the pixels 21b in the second group are exposed at the same timing. A first picture and a second picture obtained from the pixel signals in the groups are combined to each other, thereby generating one still picture. Therefore, since the pixel signals obtained by the exposures at the same timing are combined to each other, a still picture generated can be acquired as a natural picture.

Sine a motion picture and a still picture acquired in the period of capturing the motion picture are associated with each other and recorded, for example, at the time of handling the pictures later in a display mode which will be described later, the still picture acquired in the period of capturing the motion picture can be easily specified.

1-4. Operation in Display Mode

The operation in the display mode of the digital camera 1 will now be described. In the display mode, the motion picture and the still picture associated with each other and recorded are simultaneously displayed.

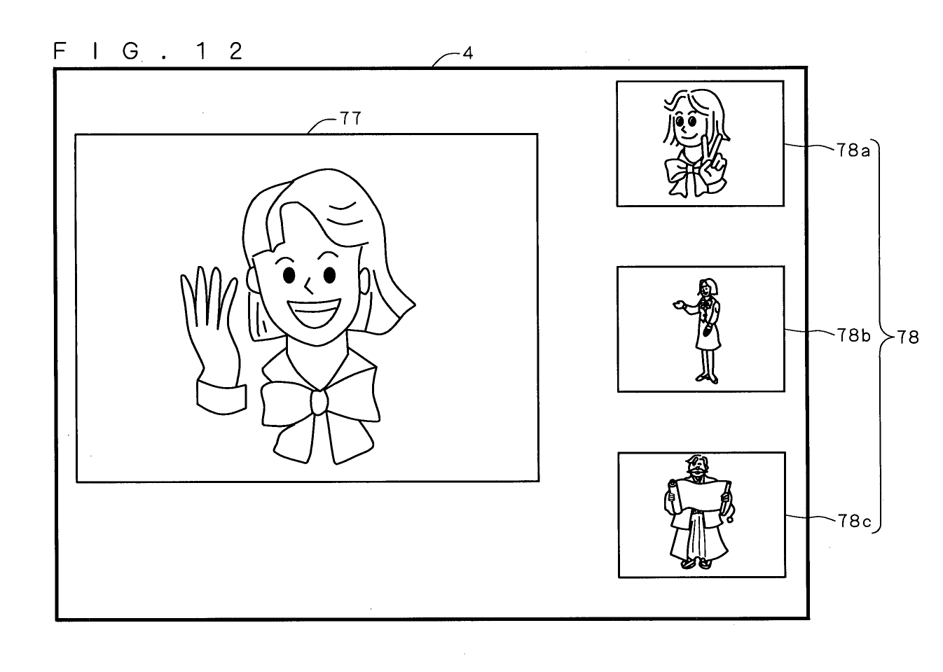

FIG. 11 is a diagram showing the flow of operations in the display mode of the digital camera 1. In the display mode, first, a selection screen for selecting a picture file to be displayed from picture files recorded in the memory card 9 is displayed. The user can select a desired picture file as a picture to be displayed by operating the cross key 37 and the like while referring to the selection screen (step S31).

In the case where the picture file selected by the user is of a still picture (“No” in step S32), the still picture is displayed on the liquid crystal monitor 4 (step S33). After the still picture is displayed, the selection screen is displayed again by a predetermined operation.

On the other hand, when the picture file selected by the user is of a motion picture (“Yes” in step S32), tag information of the motion picture (hereinafter, referred to as “target motion picture”) is read (step S34). When the file name of the still picture is written in the tag information, the file name is obtained. The obtained file name refers to the picture file of the still picture associated with the target motion picture and recorded. Therefore, based on the file name, the still picture (hereinafter, referred to as “related still picture”) obtained in the period of capturing the target motion picture is specified (step S35).

The tag information of the specified related still picture is referred to and the “still picture capture time” of the related still picture is obtained. On the basis of the “still picture capture time” of the related still picture, time from the start time point of the target motion picture capture to the acquisition time point of the related still picture is obtained as “relative image capture time”. More concretely, by subtracting the “motion picture start time” written in the tag information of the target motion picture from the “still picture capture time” of the related still picture, “relative capture time” is obtained. When a plurality of related still pictures exist, the “relative capture times” of all of the related still pictures are computed (step S36).

After that, the target motion picture and the related still picture are simultaneously displayed on the liquid crystal monitor 4. At this time, with respect to the target motion picture, for example, only the first frame is displayed in a still state (step S37).

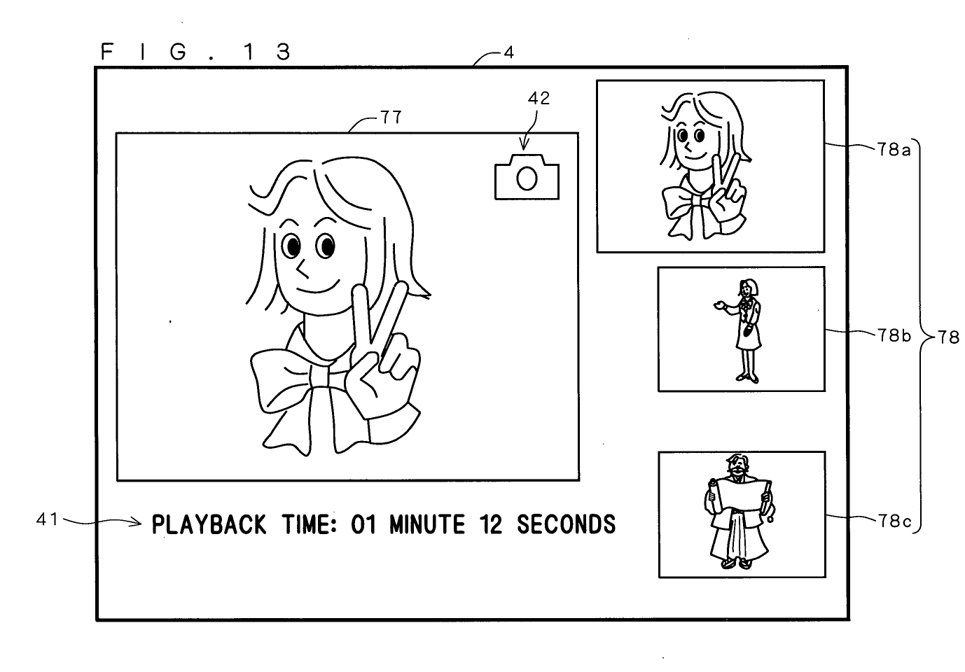

FIG. 12 is a diagram showing a display example of the liquid crystal monitor 4 when the object motion picture and the related still picture are simultaneously displayed. As shown in FIG. 12, the target motion picture 77 is displayed relatively large in a left part of the screen of the liquid crystal monitor 4, and three related still pictures 78 are arranged in the vertical direction and displayed on the right side of the target motion picture 77. For the target motion picture 77 of the example of the diagram, three related still pictures 78 exist. By such display, the still pictures captured in the period of capturing the target motion picture can be easily grasped.

Referring again to FIG. 11, when the execution button 38 is depressed in such a state, a “playback start signal” as a signal for instructing start of playback display of the target motion picture is generated (“Yes” in step S38). In response to the signal, first, counting of time by the timer 64 starts (step S39). The counted time indicates time from the start of playback display of the target motion picture (hereinafter, referred to as “playback time”).

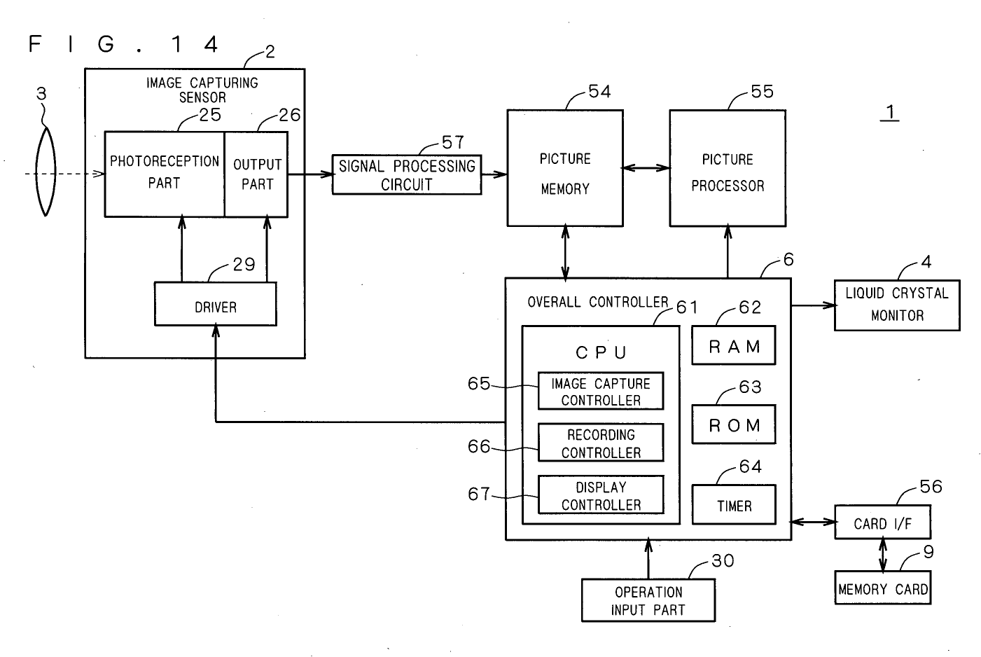

Subsequently, the target motion picture is playback displayed (step S40). FIG. 13 is a diagram showing a display example of the liquid crystal monitor 4 when the target motion picture is playback displayed. As shown in the diagram, during playback display of the target motion picture, a character string 41 indicative of playback time is displayed below the target motion picture 77. Such playback display of the target motion picture is finished when the playback time becomes equal to time corresponding to the image capture period (from the “motion picture start time” to “motion picture end time”) (step S43).

In the playback display of the target motion picture, when the playback time corresponds to time from the start time point of image capture of the target motion picture to the time point of acquisition of the related still picture, this fact is displayed. That is, when the playback time become equal to the relative image capture time, special display different from normal display is performed.

During the playback display of the target motion picture, the playback time is always checked (step S41). When the playback time becomes equal to the relative image capture time, as shown in FIG. 13, the related still picture 78 corresponding to the relative image capture time is enlargedly displayed and a predetermined image capture mark 42 is displayed (step S42). In the example of FIG. 13, a related still picture 78a is enlarged more than the other related still pictures 78b and 78c so as to be emphasized. Such special display is continued for a predetermined period (for example, one second). When a plurality of related still pictures exist, similar display is made every relative image capture time of the related still pictures. By such display, the user can easily grasp the time point the still picture is captured in the motion picture capturing period of a motion picture after the image capturing.

As described above, in the digital camera 1, at the time of displaying a motion picture, a still picture recorded so as to be associated with the motion picture is simultaneously displayed. Therefore, at the time of displaying a motion picture, the still picture captured during the period of capturing the motion picture can be easily grasped. Further, in the playback display of the motion picture, when playback time corresponds to time from the start time point of capture of the motion picture to the time point of acquisition of one still picture recorded so as to be associated with the motion picture, the special display showing the fact is made. Consequently, the time point at which the still picture is captured relative to the motion picture capturing period can be easily grasped after the image capturing.

2. Second Preferred Embodiment

A second preferred embodiment of the present invention will now be described. Although the image capturing sensor 2 has two output systems in the foregoing first preferred embodiment, the image capturing sensor 2 of the second preferred embodiment has only one output system. The outside configuration of the digital camera 1 of the second preferred embodiment is similar to that shown in FIGS. 1 and 2.

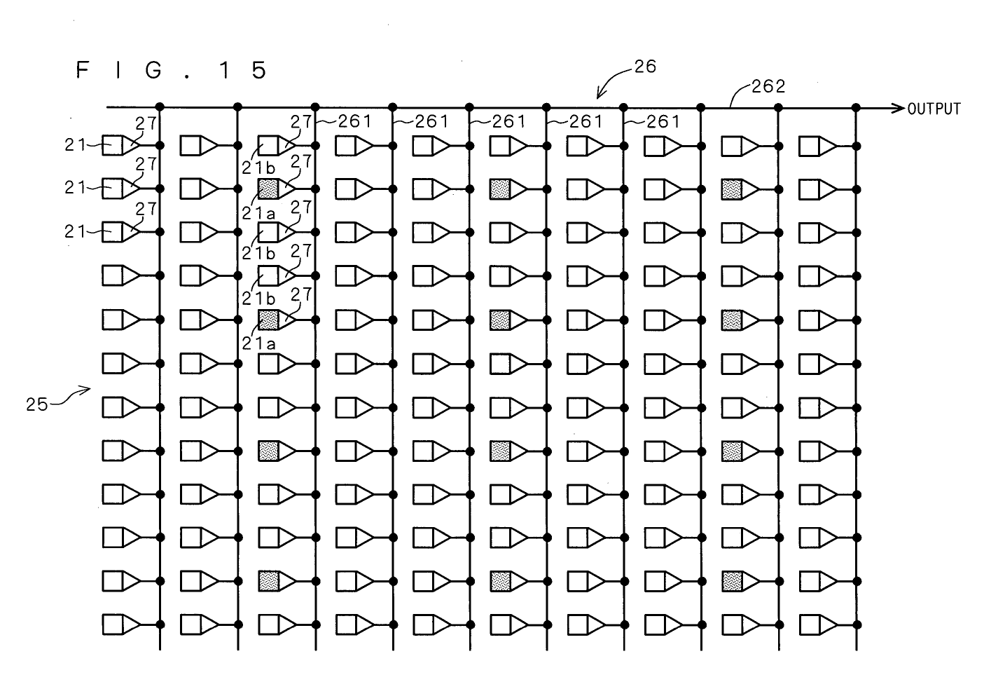

FIG. 14 is a block diagram showing main internal components of the digital camera 1 of the preferred embodiment. As shown in FIG. 14, the inside configuration of the digital camera 1 of the preferred embodiment is identical to that of the first preferred embodiment shown in FIG. 3. However, since the image capturing sensor 2 of the second preferred embodiment has only one output system, as the signal processing circuit, only one signal processing circuit 57 is provided. The configuration of the signal processing circuit 57 is similar to that of the signal processing circuits 52 and 53 of the first preferred embodiment. The image capturing sensor 2 of the second preferred embodiment takes the form of a C-MOS sensor and has a driver 29 in addition to a photoreception part 25 and an output part 26. The driver 29 also transmits a signal for driving to the photoreception part 25 and the output part 26 on the basis of a signal from the overall controller 6.

The photoreception part 25 of the image capturing sensor 2 is constructed, in a manner similar to the first preferred embodiment, by the plurality of pixels 21 two-dimensionally arranged as 1920 pixels in the horizontal direction×1440 pixels in the vertical direction as shown in FIG. 4. The plural pixels 21 are also divided into two groups; the group of the pixels 21a for acquiring pixel signals used for generating a motion picture and the group of the other pixels 21b mainly used for generation of a still picture. The layout of the pixels 21a of the first group and the pixels 21b of the second group is similar to that of the first preferred embodiment. Also in the image capturing sensor 2 of the second preferred embodiment, the pixels 21a of 640 pixels in the horizontal direction×480 pixels in the vertical direction exist. In the image capturing sensor 2 of the second preferred embodiment, the pixel signals of both of the first and second groups are outputted from the output part 26 having only one output system.

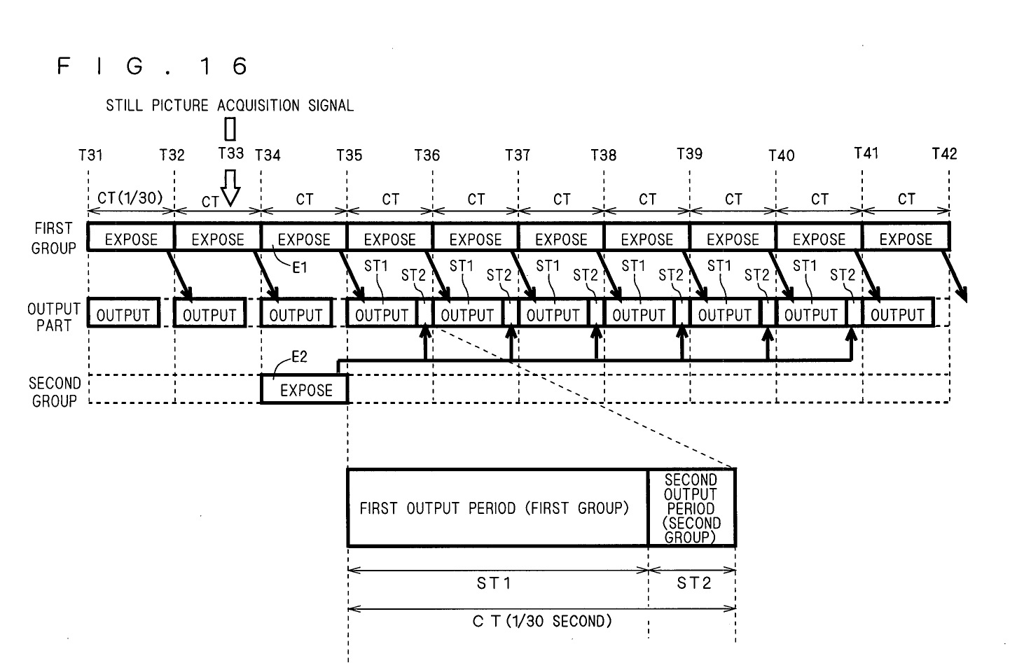

FIG. 15 is a diagram schematically showing the configuration of the image capturing sensor 2 of the second preferred embodiment including the output part 26. The output part 26 has a plurality of vertical output lines 261 each disposed for each of vertical pixel columns of the photoreception part 25 and one horizontal output line 262 electrically connected to the plurality of vertical output lines 261.

As shown in FIG. 15, a transistor 27 functioning as an amplifier and a switch is disposed for each of the pixels 21 of the image capturing sensor 2 of the preferred embodiment. Each pixel 21 is connected to the vertical output line 261 via the transistor 27. When a signal is supplied from the driver 29 to the gate electrode of a certain transistor 27, the pixel signal stored in the pixel 21 corresponding to the transistor 27 is amplified and the amplified signal is sent to the vertical output line 261. The pixel signal is further sent from the vertical output line 261 to the horizontal output line 262 and is outputted from the horizontal output line 262. The pixel signals of all of the pixels 21 are outputted in such a manner. Therefore, the pixel signals of all of the pixels 21 of the image capturing sensor 2 are outputted via the one horizontal output line 262 as one output system.

The driver 29 can selectively supply a signal to the gate electrode of an arbitrary transistor 27. Consequently, the image capturing sensor 2 can selectively output the pixel signal of the arbitrary pixel 21. Therefore, irrespective of the sequence order of the pixels 21 in the photoreception part 25, the image capturing sensor 2 can also output the pixel signals of the pixels 21 in an arbitrary order. Hereinafter, the function capable of outputting the pixel signals of arbitrary pixels 21 of the image capturing sensor 2 in an arbitrary order will be referred to as an “arbitrary output function”.

The operation in the “motion picture mode” of the digital camera 1 of the second preferred embodiment is similar to that shown in FIG. 8. Therefore, also in the digital camera 1 of the second preferred embodiment, when the “still picture acquisition signal” is generated during the motion picture capturing period, in response to the signal, a still picture is acquired. At this time, the pixel signals in the first group corresponding to each frame are repeatedly outputted in predetermined time cycles without being influenced by output of the second group. In the second preferred embodiment, to realize the operation, the “arbitrary output function” of the image capturing sensor 2 is used and the pixel signals in the first group and the pixel signals in the second group are outputted substantially in parallel from the output part 26 having only one output system.

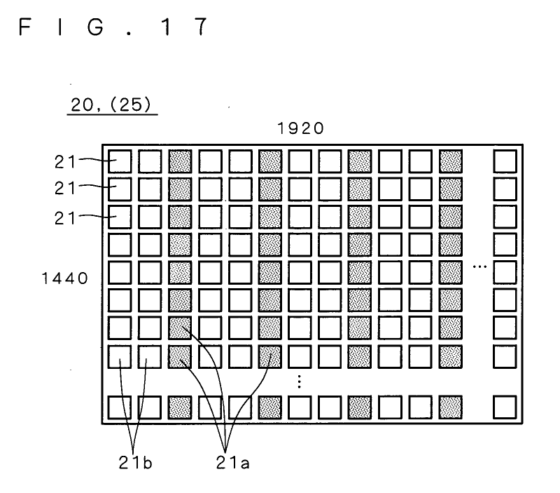

FIG. 16 is a time chart showing the operation of the digital camera 1 in the second preferred embodiment performed when the “still picture acquisition signal” is generated in the motion picture capturing period.

Also in the second preferred embodiment, within the motion picture capturing period, as shown in the diagram, exposure of the first group and output from the output part 26 of the pixel signals related to the exposure are repeated in the cycles of 1/30 second. At this time, the signal is repeatedly sent from the driver 29 only to the transistors 27 of the pixels 21a of the first group in the cycles of 1/30 second. The output part 26 of the second preferred embodiment can output all of the pixel signals in the first group related to exposure of once in a period shorter than 1/30 second.

When the “still picture acquisition signal” is generated, for example, at the time point T33 in such a state, in response to the signal, the exposure E2 of the second group is made. Also in the second preferred embodiment, the timings of the exposure E2 of the second group and the exposure E1 of the first group are synchronized by the signal from the driver 29 (between time points T34 and T35).

After the time point T35 when the exposures E1 and E2 are completed, the pixel signals of the first group as a frame in a motion picture are repeatedly outputted from the output part 26 in the cycles of 1/30 second. On the other hand, the pixel signals obtained by the exposure E2 of the second group are outputted from the output part 26 between repeated output periods of the pixel signals of the first group.

More concretely, as shown in a lower part of FIG. 16, one cycle (1/30 second) in which each frame in a motion picture is to be outputted is set as one process cycle CT. The process cycle CT is divided into a first output period ST1 for outputting the pixel signals of the first group and a second output period ST2 for outputting pixel signals of the second group. The first output period ST1 is a period in which all of pixel signals in the first group related to exposure of once can be outputted. In other words, in the process cycle CT, the period in which outputting of all of pixel signals of the first group can be completed is the first output period ST1, and the remaining period obtained by subtracting the first output period ST1 from the process cycle CT is the second output period ST2.

Such an operation is enabled by the “arbitrary output function” of the image capturing sensor 2. From the driver 29, the signal is supplied to the transistors 27 of the pixels 21a of the first group in the first output period ST1 and the signal is supplied to the transistors 27 of the pixels 21b of the second group in the second output period ST2.

Since all of the pixel signals obtained by the exposure E2 of the second group cannot be outputted only in one second output period ST2, they are outputted in a plurality of second output periods ST2. Therefore, after completion of the exposure E2 of the second group, the second output period ST2 is set over the plurality of process periods CT. In the example of the diagram, the second output period ST2 is set over six process cycles CT from the time point T35 to T41, and the pixel signals of the second group are outputted in six times. The operation is also realized by the “arbitrary output function” of the image capturing sensor 2. The operation is also realized by the “arbitrary output function” of the image capturing sensor 2. Each of the pixel signals of the pixels 21b of the second group obtained by the exposure E2 waits to be outputted until the signal is sent to the corresponding transistor 27. The pixel signal in the output standby is held in each pixel 21b.

As described above, in the second preferred embodiment, the process cycle CT is divided into periods each for outputting the pixel signals of each of the two groups. With the configuration, the output part 26 having only one output system can also output the pixel signals of the first group and the pixel signals of the second group substantially in parallel.

To the first group, the period in which outputting of all of the pixel signals can be completed is assigned. To the second group, the remaining period is assigned. Consequently, the pixel signals of the first group of the motion picture can be outputted more preferentially than the second group, and the pixel signals of the first group corresponding to one frame can be outputted in a predetermined time cycle without being influenced by the output state of the pixel signals of the second group. Therefore, even in the period of the process on the still picture, a frame for a motion picture can be acquired in the predetermined time cycle, and a motion picture without a frame dropout can be acquired.

The pixel signals of the first group and the pixel signals of the second group which are outputted are processed in a manner similar to the foregoing first preferred embodiment.

3. Modifications

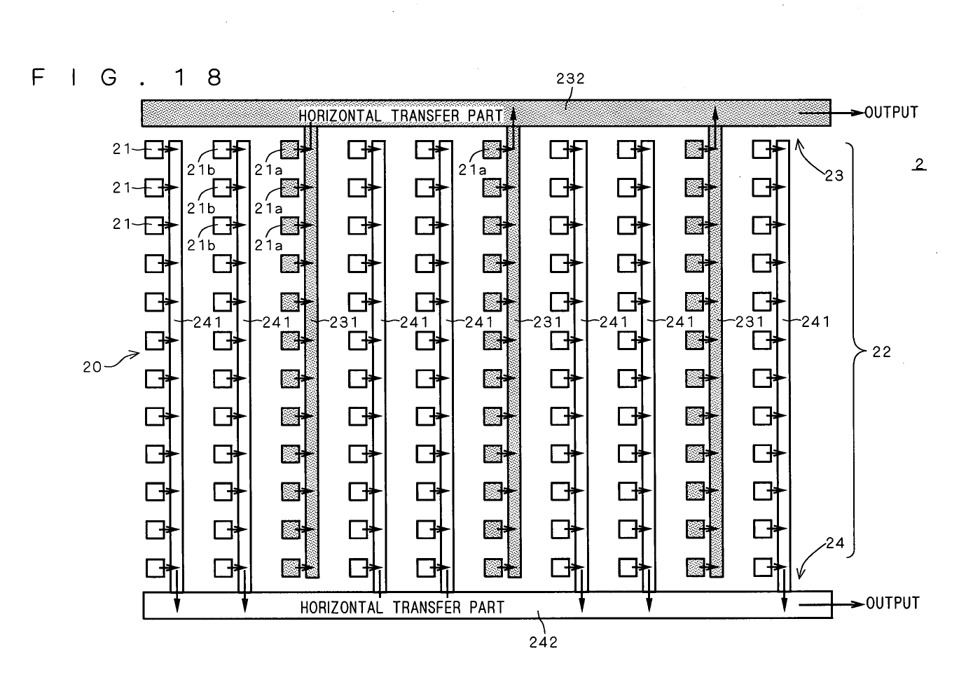

The present invention is not limited to the way of dividing the plurality of pixels of the image capturing sensor 2 to the first and second groups but the pixels may be divided in various modes. For example, as shown in FIG. 17, the dividing operation may be also performed so that pixels in the same vertical pixel column always belong to the same group in the photoreception part 20 (25). In the example of FIG. 17, the vertical pixel columns made of only the pixels 21a of the first group exist at the ratio of one in every three vertical pixel columns.

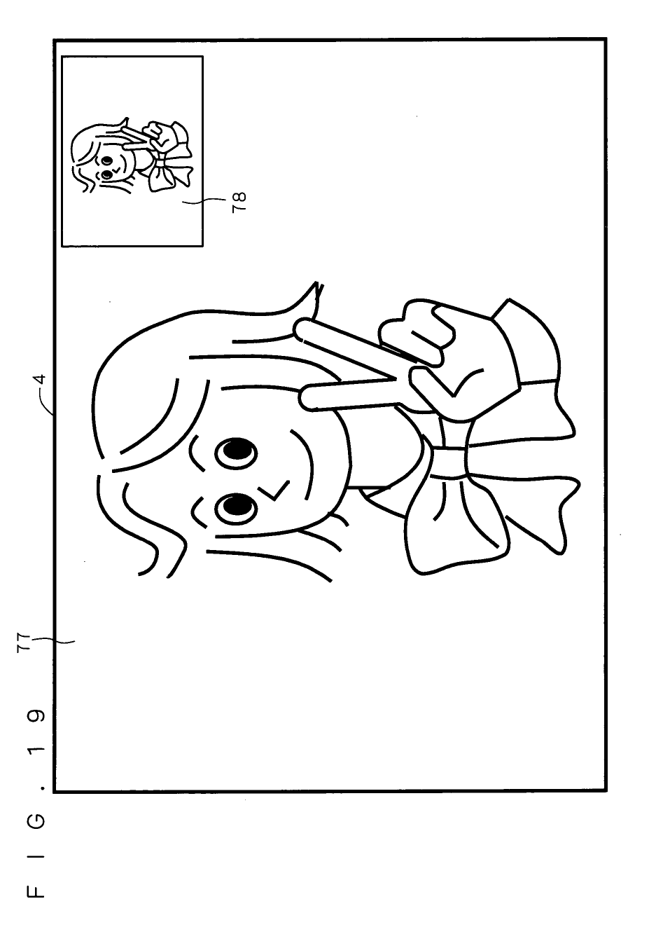

When the layout of the pixels as shown in FIG. 17 is employed in the foregoing first preferred embodiment, the number of the vertical transfer parts can be reduced. FIG. 18 is a diagram schematically showing the configuration of the image capturing sensor 2 taking the form of a CCD sensor employing the layout of pixels of FIG. 17. As shown in the diagram, each vertical pixel column includes pixels of only the same group. Consequently, for the vertical pixel column including only the pixels 21a of the first group, only the vertical transfer part 231 of the first output system 23 is disposed. On the other hand, for the vertical pixel column including only the pixels 21b of the second group, only the vertical transfer part 241 of the second output system 24 is disposed. Therefore, since it is unnecessary to dispose two vertical transfer parts for one vertical pixel column, the configuration of the image capturing sensor 2 can be simplified.

Although the number of groups to which the pixels of the image capturing sensor 2 are divided is two in the foregoing preferred embodiments, it may be three or more.

In the foregoing embodiments, one of the groups is to mainly acquire a motion picture and the other group is to mainly acquire a still picture. As long as the groups obtain pictures having different properties, the kind of a property of each picture is not particularly limited. For example, one of the groups may serve the purpose of acquiring a motion picture of a relatively high frame rate and the other group may serve the purpose of acquiring a motion picture of a relatively low frame rate. Alternatively, one of the groups may serve the purpose of acquiring a picture of a relatively high color temperature and the other group may serve the purpose of acquiring a picture of a relatively low color temperature.

Although the exposure time of the exposure E1 of the first group and that of the exposure E2 of the second group are matched with each other in the foregoing preferred embodiments, for example, in the case where the luminance of the subject is relative low, the time of the exposure E2 of the second group may be set to be longer than that of the exposure E1 of the first group.

Although a motion picture and a still picture are associated with each other by writing the file name of a still picture in the tag information of a motion picture in the foregoing preferred embodiments, the present invention is not limited to the associating method. For example, only by writing “peculiar code of digital camera”, “motion picture start time”, and “motion picture end time” in the tag information of a motion picture and writing “peculiar code of digital camera” and “still picture capture time” in the tag information of a still picture, the motion picture and the still picture captured in the period of capturing the motion picture can be substantially associated with each other. In an image capturing apparatus having a position acquiring function such as a GPS, by writing the same “position information (position of image capturing)” in tag information of both of the motion and still pictures, the motion and still pictures can be associated with each other. Further, in an image capturing apparatus to which character information can be inputted, by writing the same “character information (title)” in the tag information of both of the motion and still pictures, the motion and still pictures can be associated with each other.

The display mode (including the special display mode) of the liquid crystal monitor 4 in the playback display of a motion picture is not limited to the display mode shown in FIG. 13. For example, as shown in FIG. 19, it is also possible to playback-display a motion picture on the entire region of the screen of the liquid crystal monitor 4 and, only when the playback time becomes equal to the relative image capture time, display the related still picture 78 corresponding to the relative image capture time so as to be superimposed on the motion picture.

Although the special display is performed for a predetermined period when the playback time becomes equal to the relative image capture time in the foregoing preferred embodiments, alternatively, special display may be performed when the reproduction time becomes, for example, predetermined time (for example, 0.5 second) to the relative image capture time. It is also possible to display a countdown from predetermined time (for example, 10 seconds) to the relative image capture time. In such a manner, the relative time point at which the still picture is acquired in the motion picture capture period can be grasped more clearly.

In the foregoing preferred embodiments, the picture processor 55 for performing a picture process of, for example, combining the pixel signals of the first group and the pixel signals of the second group to thereby generate a still picture is constructed separately from the image capturing sensor 2. Alternatively, the image capturing sensor 2 may include a circuit having functions similar to those of the picture processor 55.

Although one still picture is generated by combining the first and second pictures in the foregoing preferred embodiments, one still picture may be generated only from the second picture by pixel interpolation on the second picture (the picture made of the pixel signals in the second group) by the picture processor 55. The pixel interpolation is a process of creating a pixel signal in a position in which no pixel signal exists in the second picture by replacing, averaging, or the like with peripheral pixel signals.

While the invention has been shown and described in detail, the foregoing description is in all aspects illustrative and not restrictive. It is therefore understood that numerous modifications and variations can be devised without departing from the scope of the invention.

1. An image capturing sensor comprising:
a plurality of pixels divided into two or more groups and acquiring pixel signals by exposure to light; and
an output part having two or more output systems corresponding to said two or more groups in a one-to-one corresponding manner, wherein
each of said two or more output systems outputs pixel signals acquired by the pixels of the corresponding group.

2. The image capturing sensor according to claim 1, wherein
said two or more groups include a first group for repeatedly acquiring a pixel signal used for generating a motion picture in predetermined time cycles.

3. The image capturing sensor according to claim 2, wherein
said two or more groups include a second group for acquiring a pixel signal used for generating a still picture in response to generation of a predetermined instruction signal.

4. The image capturing sensor according to claim 3, wherein
when said instruction signal is generated in the case where the pixels of said first group are repeatedly exposed in said predetermined time cycles, the pixels of said first group are continuously repeatedly exposed.

5. The image capturing sensor according to claim 4, wherein
when said instruction signal is generated in the case where the pixels of said first group are repeatedly exposed in said predetermined time cycles, the pixels of said second group are exposed at the same timing as that of the pixels of said first group.

6. The image capturing sensor according to claim 5, further comprising:
a picture processor for generating a still picture by combining pixel signals acquired by the pixels in said first group and pixel signals acquired by the pixels in said second group by the exposure of the same timing.

7. The image capturing sensor according to claim 3, further comprising:
a picture processor for generating a still picture by interpolation using the pixel signals acquired by the pixels in said second group.

8. An image capturing sensor comprising:
a plurality of pixels divided into two or more groups and acquiring pixel signals by exposure to light;
an output part for outputting pixel signals acquired by said plurality of pixels; and
a drive part for repeatedly driving said output part in predetermined process cycles, wherein
each of said process cycles is divided into two or more output periods for outputting the pixel signals acquired by said two or more groups from said output part.

9. The image capturing sensor according to claim 8, wherein
said two or more groups include a first group for repeatedly acquiring a pixel signal used for generating a motion picture in predetermined time cycles.

10. The image capturing sensor according to claim 9, wherein
said two or more groups include a second group for acquiring a pixel signal used for generating a still picture in response to generation of a predetermined instruction signal.

11. The image capturing sensor according to claim 10, wherein
when said instruction signal is generated in the case where the pixels of said first group are repeatedly exposed in said predetermined time cycles, the pixels of said first group are continuously repeatedly exposed.

12. The image capturing sensor according to claim 11, wherein
when said instruction signal is generated in the case where the pixels of said first group are repeatedly exposed in said predetermined time cycles, the pixels of said second group are exposed at the same timing as that of the pixels of said first group.

13. The image capturing sensor according to claim 12, further comprising:
a picture processor for generating a still picture by combining pixel signals acquired by the pixels in said first group and pixel signals acquired by the pixels in said second group by the exposure of the same timing.

14. The image capturing sensor according to claim 10, further comprising:
a picture processor for generating a still picture by interpolation using the pixel signals acquired by the pixels in said second group.

15. An image capturing apparatus comprising:
a plurality of pixels divided into two or more groups for acquiring pictures of different properties, and acquiring pixel signals by exposure to light; and
an output part capable of outputting the pixel signals acquired by said two or more groups in parallel.

16. The image capturing apparatus according to claim 15, wherein
said two or more groups include a first group for repeatedly acquiring a pixel signal used for generating a motion picture in predetermined time cycles.

17. The image capturing apparatus according to claim 16, wherein
said two or more groups include a second group for acquiring a pixel signal used for generating a still picture in response to generation of a predetermined instruction signal.

18. The image capturing apparatus according to claim 17, wherein
when said instruction signal is generated in the case where the pixels of said first group are repeatedly exposed in said predetermined time cycles, the pixels of said first group are continuously repeatedly exposed.

19. The image capturing sensor according to claim 18, wherein
when said instruction signal is generated in the case where the pixels of said first group are repeatedly exposed in said predetermined time cycles, the pixels of said second group are exposed at the same timing as that of the pixels of said first group.

20. The image capturing apparatus according to claim 19, further comprising:
a picture processor for generating a still picture by combining pixel signals acquired by the pixels in said first group and pixel signals acquired by the pixels in said second group by the exposure of the same timing.

21. The image capturing apparatus according to claim 17, further comprising:
a picture processor for generating a still picture by interpolation using the pixel signals acquired by the pixels in said second group.

22. The image capturing apparatus according to claim 20, further comprising:
a recording controller for recording a still picture generated by said picture processor and a motion picture including the pixel signals acquired by the pixels in said first group as a part of said still picture so that said still picture and said motion picture are associated with each other.

23. The image capturing apparatus according to claim 22, further comprising:
a display capable of displaying said still picture and said motion picture; and
a display controller, when said display displays said motion picture, for simultaneously displaying said still picture recorded so as to be associated with said motion picture onto said display.

24. The image capturing apparatus according to claim 22, further comprising:
a display capable of displaying said still picture and said motion picture; and
a display controller, during playback display of said motion picture on said display, when playback time from start of playback display corresponds to relative image capture time which is from a start time point of capture of said motion picture to a time point of acquisition of a sill picture recorded so as to be associated with said motion picture, for displaying the fact that said playback time became equal to said relative image capture time onto said display.

25. An image capturing apparatus comprising:
an image capturing part capable of acquiring a still picture within a period of capturing a motion picture; and
a recording controller for recording a motion picture and a still picture which is acquired within the period of capturing said motion picture so as to be associated with each other.

26. The image capturing apparatus according to claim 25, further comprising:
a display capable of displaying said still picture and said motion picture; and
a display controller, when said display displays said motion picture, for simultaneously displaying said still picture recorded so as to be associated with said motion picture onto said display.

27. The image capturing apparatus according to claim 25, further comprising:
a display capable of displaying said still picture and said motion picture; and
a display controller, during playback display of said motion picture on said display, when playback time from start of playback display corresponds to relative. image capture time which is from a start time point of capture of said motion picture to a time point of acquisition of a sill picture recorded so as to be associated with said motion picture, for displaying the fact that said playback time became equal to said relative image capture time onto said display.
